(19) United States
(12) Patent Application Publication
(10) Pub. No.: US 2021/0139737 A1
(43) Pub. Date: May 13, 2021

(54) AQUEOUS COATING COMPOSITION FOR SIDE SEAM STRIP OR SIDE SEAM COATING ON THREE-PIECE CAN

(71) Applicant: Guangdong Huarun Paints Co. Ltd., Guangdong (CN)

(72) Inventors: Shengzhe Hu, Guangdong (CN); Jinhao Liang, Guangdong (CN); Xi Zhao, Guangdong (CN); Venkata Durga Satyanarayana Maleapati, Tuas (SG); Xiaodong Wu, Shanghai (CN)

(73) Assignee: Guangdong Huarun Paints Co. Ltd., Guangdong (CN)

(21) Appl. No.: 16/623,732

(22) PCT Filed: Jun. 21, 2018
(86) PCT No.: PCT/CN2018/092181

§ 371 Date: Dec. 17, 2019

(30) Foreign Application Priority Data
Jun. 21, 2017 (CN) 201710475758.4

(51) Int. Cl. C09D 175/04; C09D 133/06; C08G 18/10; C08G 18/62; C08G 18/78; C08G 18/80; C08K 5/3492; C08K 5/3445; C08K 5/49

(52) U.S. Cl. CPC C09D 175/04; C09D 133/066; C08G 18/10; C08G 18/6254; B65D 1/12; C08G 18/80; C08K 5/34922; C08K 5/3445; C08K 5/49; C08G 18/7843

(57) ABSTRACT

An aqueous coating composition includes: i) an aqueous dispersion of a hydroxyl functional acrylic polymer; ii) a urethane component; iii) a hydroxyl reactive crosslinking agent different from component ii); and iv) an aqueous liquid carrier. The coating composition has a volatile organic (VOC) content of less than 420 g/L, and may be applied to a side seam strip or a side seam of a three-piece can.

### TECHNICAL FIELD

The present invention relates to an aqueous coating composition. More particularly, the present invention relates to a low VOC aqueous coating composition suitable for forming a side seam strip or a side seam coating on a three-piece can, in particular, a three-piece can for food or beverage; a three-piece can containing a side seam strip or a side seam coating formed using the coating composition; and a method for forming the side seam strip or the side seam coating.

### BACKGROUND

A three-piece can consists of a can bottom, a can body (also referred to as a side wall) and a lid. At present, in the manufacturing process of three-piece cans, such as food or beverage cans, the side seams of the can are mainly joined using fusion-welding or soldering techniques. The side seams formed in this way can require additional coating protection, such as side seam strips or side seam coatings.

Designers of side seam strips or side seam coatings are faced with a variety of challenges when developing appropriate coatings. For example, it is desirable for the coating to adhere adequately to the side seam, to exhibit proper flexibility, to have a desired salt tolerance, and to be resistant to chemical wiping. The coating should also be able to withstand manufacturing steps such as, for example, high-temperature steaming, needed to form the final piece. It is often very difficult to formulate a coating with properly balanced coating properties at a reasonably low cost.

At present, suitable coating compositions for forming side seam strips or side seam coatings include powder coating compositions and solvent based coating compositions. The powder coating composition has some advantages such as, for example, more suitable environmental properties compared to solvent based coating compositions, high production efficiency, excellent coating performance, and outstanding economic efficiency. However, powder coating compositions also have disadvantages like low fluidity, and application that is difficult to control, and their application can require expensive coating equipment. The solvent based coating composition has advantages like good fluidity, good wetting and covering properties, and ease in handling; but solvent based coating composition will inevitably cause environmental pollution and release a large amount of volatile organic compounds (VOC).

Therefore, a low VOC aqueous coating composition suitable for forming a side seam strip or a side seam coating on a three-piece can is desired in the coating industry.

### SUMMARY

In one aspect, the present invention provides an aqueous coating composition with a low content of volatile organic compounds (VOC). In some embodiments, the aqueous coating composition has a volatile organic (VOC) content of less than 420 g/L. The aqueous coating composition is suitable for forming a side seam strip or a side seam coating on a three-piece can, in particular, on metal three-piece cans for food or beverages. The aqueous coating composition includes: i) an aqueous dispersion of a hydroxyl functional acrylic polymer; ii) a urethane component; iii) a hydroxyl reactive crosslinking agent different from component ii); and iv) an aqueous liquid carrier.

In various embodiments, the urethane component includes a water-dispersible polyurethane polymer, a protected isocyanate, and mixtures and combinations thereof.

In one embodiment, the aqueous coating composition further includes a phosphorylated adhesion promoter.

In another aspect, the present disclosure is directed to a three-piece can, in particular, a three-piece can for food or beverages. The can includes a can bottom and a can body, and the can body has a side seam formed by fusion welding or soldering the metal sheet itself together. An outer surface of the side seam, an inner surface of the side seam, or both are coated with a side seam strip or a side seam coating derived from the aqueous coating compositions of the present disclosure.

In another aspect, the present disclosure is directed to a method for forming a side seam strip or a side seam coating on a three-piece can, the method including: i) providing the aqueous coating composition; ii) applying the coating composition to the side seam of the three-piece can; and iii) heating the side seam to a peak metal temperature of at least 180° C., thereby forming the side seam strip or the side seam coating.

When compared with a solvent based coating composition conventionally used to form a side seam or a side seam coating, the aqueous coating composition of the present disclosure has similar protective properties, but with a lower VOC content of less than 420 g/L, less than 300 g/L, less than 250 g/L, and even less than 200 g/L.

In some embodiments, the aqueous coating composition obtained by introducing urethane components into hydroxyl-containing acrylic-based latex can provide side seam strips or side seam coatings with better adhesion, chemical resistance and flexibility, compared to a control aqueous coating composition without the urethane component. In some embodiments, the addition of phosphorylated adhesion promoters can further improve the flexibility and chemical resistance of the side seam strip or side seam coating, such as wedge bending and resistance to MEK wiping.

Details of one or more embodiments of the present invention are provided in the description below. Other features, objectives, and advantages of the present invention will become apparent through the description and the claims.

### Definitions

As used herein, when quantifiers are not used, “at least one”, and “one or more” can be used interchangeably. Thus, for example, a coating composition comprising a crosslinking agent can be interpreted to mean that the coating composition comprises “one or more” crosslinking agents.

Where the composition is described as comprising or containing a particular component, it is expected that the composition does not exclude the optional components not covered by the present invention; and it is expected that the composition can be formed by or consisted of the components involved; or where the method is described as comprising or containing special process steps, it is expected that the method does not exclude optional process steps not covered by the present invention and the method may be formed or consist of the process steps involved.

For simplicity, only some numerical ranges are explicitly disclosed herein. However, any lower limits may be combined with any upper limits to form ranges not recorded specifically; and any lower limits may be combined with any other lower limits to form ranges not recorded specifically; similarly, any upper limits may be combined with any other upper limits to form ranges not recorded specifically. Furthermore, although not specified, each point or individual value between the range endpoints is contained within that range. Thus, each point or individual value, acting as the lower or upper limit of itself, can be combined with any other point or a single numerical combination or with any other lower or upper limit to form ranges not recorded specifically.

An “aqueous dispersion” refers to a stable dispersion of synthetic resin (i.e., polymer) in an aqueous liquid medium in particulate form; which can optionally be stabilized by a suitable dispersing aid, such as a surfactant. The synthetic resin can be prepared by an emulsion polymerization process or a solution polymerization process.

The term “urethane component” refers to any compound or polymer containing urethane bonds (—NH—CO—O—).

Herein, the term “polyurethane” refers to polymers containing several urethane bonds (—NH—CO—O—) in the framework. Generally, the framework of the polymer may optionally contain, in addition to the urethane bonds, ester bonds, ether bonds, urea bonds, urea-based urethane bonds, isocyanurate bonds, and the like.

In the context of “water-dispersible polyurethane,” the term “water dispersible” means that the polyurethane can be mixed with water (or an aqueous carrier) to form a stable mixture. The term “water dispersible” is intended to include the term “water-soluble.” In other words, water-soluble polymers are also considered as water-dispersible polymers by definition. The polyurethane can be water-dispersible in any suitable manner including the introduction of a non-ionic water-dispersible group, an ionic water-dispersible group, or a combination thereof in the molecular chain of the polyurethane (including framework, side-chain, terminal, or a combination thereof). For example, the water-dispersible polyurethane may be an acid functional polyurethane polymer.

The term “protected isocyanate” refers to an isocyanate that is protected by an active hydrogen-containing substance. In one embodiment, the protected isocyanate is fully protected by the active hydrogen-containing substance, which can generate isocyanate after cracking by heating (e.g., 120° C. or a higher temperature), thereby recovering its reactivity.

The term “crosslinking agent” refers to molecules that are capable of forming covalent links between polymers or different regions of the same polymer.

The term “substantially free of” an active compound means that the composition of the present invention comprises less than 1000 parts per million (ppm) of the active compound. The term “essentially free of” an active compound means that the composition of the present invention comprises less than 100 ppm of the active compound. The term “essentially completely free of” an active compound means that the composition of the present invention comprises less than 5 ppm of the active compound. The term “completely free of” an active compound means that the composition of the present invention comprises less than 20 parts per billion (ppb) of the active compound.

When used in the context of “applying the coating composition onto the side seam,” the term “on” includes that the coating composition is directly or indirectly coated onto the side seam. Thus, for example, the coating composition being coated onto the primer layer on the side seam is considered that the coating composition is coated on the side seam.

The term “polymer” includes homopolymers and copolymers (i.e., polymers of two or more different monomers). Similarly, the term “polyurethane polymer” includes both homopolymers and copolymers (e.g., polyester-polyurethane polymers).

The term “VOC” refers to any organic liquid or solid that is capable of spontaneously vaporizing under normal temperature and pressure of the environment where it is located. In the coating industry, volatile organic compounds typically include hydrocarbons, aldehydes, ketones, alcohols, chlorohydrocarbons, and the like.

The term “three-piece can” refers to a can-type packaging container formed from a metal sheet by a process such as crimping, bonding, fusion welding or soldering, consisting of a can bottom, a can body (also referred to as a side wall) and a lid, wherein the can body has a seam.

In the detailed descriptions and claims, the terms “comprising” and “including” and the variants thereof do not have a limiting meaning.

The terms “preferred” and “preferably” refer to embodiments of the invention that may provide some benefits in some cases. However, other embodiments may also be preferred in the same or other circumstances. Further, the description of one or more preferred embodiments does not imply that other embodiments are not available; the one or more preferred embodiments are not intended to exclude other embodiments from the scope of the invention.

### DETAILED DESCRIPTION OF THE EMBODIMENTS

In one aspect, the present disclosure is directed to an aqueous coating composition suitable for forming a side seam strip or a side seam coating on a three-piece can. In some embodiments, the metal three-piece can be used to house food or beverage. The coating composition includes: i) an aqueous dispersion of a hydroxyl functional acrylic polymer; ii) a urethane component; iii) a hydroxyl reactive crosslinking agent different from component ii); and iv) an aqueous liquid carrier. The coating composition has a VOC content of less than 420 g/L, less than 300 g/L, less than 250 g/L, less than 200 g/L, less than 180 g/L, or even as low as 170 g/L.

### An Aqueous Dispersion of a Hydroxyl Functional Acrylic Polymer

The aqueous coating composition includes an aqueous dispersion of a hydroxyl functional acrylic polymer as a base resin.

In one embodiment, the hydroxyl functional acrylic polymer is an emulsion polymerized latex polymer whose aqueous dispersion is prepared through emulsion polymerization, and thus can also be simply referred to as an “aqueous latex.” The emulsion polymerization process typically includes the following steps: optionally, the polymerizable monomer is dispersed into an emulsion in water by the action of suitable emulsifiers and/or dispersion stabilizers and by stirring; and the polymerization of the monomer is initiated, for example, by adding an initiator. In some embodiments, the polymeric particles can be modified by organic functional groups (including, but not limited to, carboxyl, hydroxyl, amino, sulfonic acid groups, and the like), thereby obtaining an aqueous latex with the desired properties (e.g., dispersibility). Thus, in the present disclosure, the term “aqueous latex” includes not only a dispersion of unmodified polymeric particles in an aqueous medium, but also a dispersion of polymer particles in an aqueous medium modified by organic functional groups.

The size of the polymer particles in the aqueous latex obtained commercially or by the method described above can be measured using Z-average particle size. The Z-average particle size refers to the size of particles determined using a dynamic light scattering method, such as using Malvern Zetasizer 3000 HS microparticle size analyzer. In various embodiments, the Z-average particle size of the polymer particles of the aqueous latex can be up to 200 nm, or less than 180 nm, or less than 150 nm. However, the z-average particle size of the polymeric particles is preferably at least 50 nm, at least 80 nm or more, or at least 100 nm or more. In some embodiments, preferred embodiments of the present invention, the polymer particles of the aqueous latex have a Z-average particle size of 100 to 200 nm.

In another embodiment, the hydroxyl functional acrylic polymer is polymerized in an organic solution; the aqueous dispersion thereof being obtained by re-dispersing the prepared polymer in water. The solution polymerization process typically includes the following steps: dissolving the polymerizable monomer in an organic solvent; and, for example, adding an initiator to initiate polymerization of the monomer; and a post-treatment is then performed to obtain the product. In some embodiments, the polymeric particles can be modified by, for example, hydrophilic functional groups (including, but not limited to, cationic hydrophilic groups, nonionic hydrophilic groups, anionic hydrophilic groups, and the like), thereby obtaining desired properties, such as water dispersibility.

The framework of an acrylic polymer containing hydroxyl groups can have any suitable terminal group. In some embodiments, which are not intended to be limiting, the framework of the acrylic polymer is hydroxyl-terminated and/or carboxyl-terminated, more preferably hydroxyl terminated.

The hydroxyl-functional acrylic polymer may have any suitable hydroxyl value. The hydroxyl value is typically expressed as milligrams of potassium hydroxide (KOH) equivalent to a hydroxyl content in 1 gram of hydroxyl-containing substance. In various embodiments, the hydroxyl-functional acrylic polymer has a hydroxyl value of at least 5 mg KOH/g polymer, at least 10 mg KOH/g polymer, or at least 20 mg KOH/g polymer; but preferably the hydroxyl value should not be more than 200 mg KOH/g polymer. In some embodiments, the polymer has a hydroxyl value of from about 5 mg KOH/g polymer to about 150 mg KOH/g polymer, from about 10 mg KOH/g polymer to about 100 mg KOH/g polymer, or from about 20 mg KOH/g polymer to about 80 mg KOH/g polymer.

The hydroxyl-functional acrylic polymer may have any suitable acid value. Acid values are typically expressed as milligrams of KOH required to titrate 1 g of sample to the specified end point. Methods for determining acid values are well known in the art. The range of suitable acid values can vary based on various considered factors including, for example, whether water dispersability is required. In some embodiments, the polymer has an acid value of at least about 5 mg KOH/g polymer, or at least about 15 mg KOH/g polymer, or at least about 30 mg KOH/g polymer. However, given the practical application, the acid value of the polymer is typically less than about 200 mg KOH/g polymer, or less than about 150 mg KOH/g polymer, or less than 100 mg KOH/g polymer, or less than 50 mg KOH/g polymer.

The hydroxyl-containing acrylic polymer in the aqueous dispersion can be any type of acrylic polymer, including pure acrylate polymers, styrene-acrylate polymers, silicone-modified acrylate polymers, polyurethane-modified acrylate polymers, or a combination thereof. In some implementations, the hydroxyl-containing acrylic polymer includes a pure acrylate polymer.

In various embodiments, the aqueous dispersion of the hydroxyl functional acrylic polymer may be prepared by using appropriate polymerization methods well known to those skilled in the art, or by using any suitable commercially available product, such as VIACRYL VSC 6276 from Allnex, Neocryl A633 from DSM and WQ1229P from Valspar.

In various embodiments, based on the total weight of the aqueous coating composition, the aqueous coating composition of the present disclosure includes about 20 wt % to about 50 wt % of the aqueous dispersion described above. In some embodiments, based on the total weight of the aqueous coating composition, the amount of aqueous dispersion can be from about 22 wt %, about 25 wt %, about 28 wt %, about 30 wt % to about 45 wt %, about 40 wt %, about 38 wt %, and about 35 wt %.

### Urethane Component

The aqueous coating composition further includes a urethane component. As described above, the urethane component refers to any compound or polymer containing a urethane bond (—NH—CO—). Under film-forming conditions (such as at 120° C. or higher temperatures), the urethane component can undergo cleavage to generate isocyanates, which can crosslink with hydroxyl functional groups of a hydroxyl-containing acrylic polymer in the coating, allowing the coating formed from the aqueous coating composition of the present invention to form a three-dimensional network structure.

It is well known that wedge bending is a rigorous performance test, which offers one of the key indicators for measuring the coating applied on a three-piece can, especially the side seam strip or side seam coating applied on side seams of the three-piece can used for food or beverage. It can be difficult for known aqueous coating compositions applied on side seams of three-piece cans, especially those used for food or beverage, to achieve ideal wedge bending performance. While not wishing to be bound by any theory, presently available evidence indicates that when formulating aqueous coating compositions for forming a side seam strip or side seam coating, the aqueous coating composition obtained by introducing urethane components into hydroxyl-containing acrylic water-based latex can provide side seam strips or side seam coatings with better adhesion, chemical resistance and flexibility, and, in particular, coating wedge bending performance compared to the control aqueous coating compositions without urethane components.

Again, while not wishing to be bound by any theory, presently available evidence indicates that wedge bending is affected by both the flexibility of the coating itself and its adhesion to the substrate. In the aqueous coating composition of the present disclosure, the introduced urethane component not only increases the flexibility of the coating itself but also enhances the adhesion of the coating to the underlying substrate, thereby providing coating with significantly improved wedge bending performance, being suitable as side seam strips or side seam coatings on side seams of three-piece food or beverage cans.

In some embodiments, the aqueous coating composition includes a water-dispersible polyurethane polymer as a urethane component.

The polyurethane polymer should preferably contain a sufficient number of urethane links to provide desired coating properties for the final application. Such coating properties include, for example, flexibility, abrasion resistance and/or manufacturability (such as bending process). In various embodiments, suitable polyurethane polymers contain an average of at least about 2 urethane links per polymer molecule, or at least about 10 urethane links, or at least about 20 urethane links. The upper limit of the number of urethane links present in the polyurethane polymer is not particularly specified and may vary according to the molecular weight. In certain embodiments, however, each polymer molecule in the polyurethane polymer contains an average of less than about 1000 urethane links, less than about 200 urethane links, or less than about 50 urethane links.

The isocyanate content can be another useful measure of the number of urethane links in the polymer. In various embodiments, the polyurethane polymer is formed from a reaction mixture containing at least about 0.1 wt %, or at least about 1 wt %, or at least about 5 wt % of the isocyanate, based on all non-volatiles. The upper limit of the amount of isocyanate used is not particularly specified, which depends on the molecular weight of one or more isocyanate compounds used as reactants. Typically, however, the polyurethane polymer is formed from reaction mixtures containing less than about 35 wt %, or less than about 30 wt %, or less than about 25 wt % of the isocyanate, based on all non-volatiles. Preferably, the isocyanate is combined into the framework of the polyurethane polymer via a urethane link, and more preferably via a pair of urethane links.

The polyurethane polymer may include a framework with any suitable structural configuration. The framework may have a different structural configuration, depending on various factors such as the material used to form the framework, costs, and the desired end application of the polymer. The framework optionally contains one or more other frameworks to gradually increase links (such as condensation links), including amide links, ester links, carbonate links, ether links, imide links, imine links, urea links, and mixtures and combinations thereof. In addition, the framework of the polyurethane polymer optionally contains one or more oligomer or polymer segments selected, for example, from acrylic segments, epoxy segments, polyamide segments, polyester segments, poly (carbonate) segments, polyether segments, polyimide segments, polyethylene imine segments, polyurea segments or their copolymer segments, or mixtures and combinations thereof.

The polyurethane polymers of the present invention may have any suitable molecular weight. Considering that it is applied in an aqueous coating composition, the Mn of the polymer is typically no more than 500000, more commonly no more than 100000, and even more commonly no more than 40000. In such embodiments, the Mn of the polyurethane polymer is at least 5000, or at least 10000, or at least 30000.

The polyurethane polymer of the present invention may be formed using any suitable reactants and any suitable process. The polyurethane polymer is typically formed as follows: allowing ingredients, including one or more polyhydric alcohols, one or more isocyanate-functional compounds or polyisocyanates, and optionally one or more additional reactants (such as an organic material having one or more active hydrogen groups), to react. If necessary, the polyurethane polymer may be formed through an optional polyurethane prepolymer intermediate. If such a prepolymer is used, the prepolymer can optionally be extended using one or more chain extenders. Those chain extending techniques and materials (such as amine-functional chain extenders) described in international application number PCT/US10/42254 can be used.

As necessary, the polyurethane polymer of the present disclosure is water dispersible. The polyurethane polymer may be made water-dispersible using any suitable method, which includes the introduction of non-ionic hydrophilic groups, ionic or potentially ionic hydrophilic groups, or their combinations, into the polyurethane polymer. Preferred water-dispersible polyurethane polymers may contain an appropriate amount of ionic or potentially ionic hydrophilic groups to prepare an aqueous dispersion or solution. Suitable potentially ionic hydrophilic groups can include neutralizable groups, such as acidic groups or basic groups. At least a portion of the potentially ionic hydrophilic group can be neutralized to form an ionic hydrophilic group that can be used to disperse the polyurethane polymer in an aqueous carrier. Acidic or basic potential ionic groups can be introduced into the polymer via any suitable method.

Non-limiting examples of anionic hydrophilic groups include neutralized acid or anhydride groups, sulfate radicals (—OSO₃), phosphate radicals (—OPO₃), sulfonate radicals (—SO₂O—), phosphinate radicals (—POO—), phosphonate radicals (—PO₃), and mixtures and combinations thereof. Non-limiting examples of cationic hydrophilic groups include, but are not limited to, quaternary ammonium cationic groups, quaternary phosphonium cationic groups, tertiary sulfonium cationic groups, and mixtures and combinations thereof. Non-limiting examples of non-ionic hydrophilic groups include ethylene oxide groups. The compounds used to introduce the above groups into the polymer are known in the art.

The water-dispersible polyurethane polymer can be prepared by using appropriate methods well known to those skilled in the art, or any suitable commercially available product, such as WJ0526 from Valspar, can be used as an example.

In one embodiment, the water-dispersible polyurethane polymer can be present as a separate urethane component. In another embodiment, the water-dispersible polyurethane polymer can combine with other polymers so as to be present in the form of a polyurethane-acrylic polymer copolymer. In other embodiments, the aqueous coating composition can contain a protected isocyanate as a urethane component.

In the present disclosure, the protected isocyanate refers to the isocyanate that is protected by a substance containing active hydrogen. Non-limiting examples of protected isocyanate include protected aliphatic and/or cycloaliphatic polyisocyanates, such as HDI (hexamethylene diisocyanate), IPDI (isophorone diisocyanate), TMXDI ([diisocyanato cyclohexyl] methane), H12MDI (tetramethylene-m-dimethylbenzene diisocyanate), TMI (isopropylene dimethyl benzyl isocyanate), and their dimers or trimers. Suitable protective reagents include, for example, phenols, such as phenol, m-nitrophenol, parachlorophenol, and pyrocatechol; malonates, such as diethyl malonate, acetylacetone, ethyl acetoacetate; other protective agents, such as n-butanone oxime, ε-caprolactam and secondary amines. The protected isocyanate may have a suitable molecular weight as desired. In some embodiments, the protected isocyanate that may be used has an Mn of at least about 300, or at least about 650, or at least about 1000.

The isocyanate content in the protected isocyanate depends on the molecular weight of the protected isocyanate compound. Typically, the protected isocyanate has an isocyanate content of at least 5 wt %, or at least 10 wt %.

Protected isocyanates are commercially available. Non-limiting examples of suitable commercially available protected isocyanates include VESTANAT B 1358 A, VESTANAT EP B 1186 A, VESTANA EP B 1299 SV (obtained from Degussa Corp., Marl, Germany); and DESMODUR VPLS 2078 and DESMODURBL L3175SN (obtained from Bayer A.G., Leverkusen, Germany).

In various embodiments, based on the total weight of the aqueous coating composition, the aqueous coating composition includes from about 1 to about 10 percent by weight of the urethane component, or from about 1 wt %, 2 wt %, 3 wt %, or 4 wt % to about 9 wt %, about 8 wt %, about 7 wt %, and about 6 or 5 wt %.

### Active Hydrogen Reactive Crosslinking Agents

The aqueous coating composition further includes one or more active hydrogen-reactive crosslinking agents that are different from the urethane component. The selection of a particular crosslinking agent typically depends on the particular product to be formulated. In some embodiments of the present invention, non-limiting examples of crosslinking agents include amino resin crosslinking agents. Amino resins refer to condensation products of aldehydes such as formaldehyde, acetaldehyde, crotonaldehyde and benzaldehyde, and amino- or amide-based substances such as urea, melamine and benzoguanamine. Examples of suitable aminoplast resins include, but are not limited to, melamine-formaldehyde resins, benzoguanamine-formaldehyde resins, urea-formaldehyde resins. Condensation products of other amines and amides, such as triazines, diazines, triazoles, guanidines, guanamines and aldehyde condensates of alkyl- and aryl-substituted melamines, may also be used. Some examples of such compounds are N,N′-dimethyl urea, benzo urea, dicyandiamide, methylguanine, ethylguanine, glycoluril, cyanuric acid diamide, 2-chloro-4,6-diamino-1,3,5-triazine, 6-Methyl-2,4-diamino-1,3,5-triazine, 3,5-diaminotriazole, triaminopyrimidine, 2-mercapto-4,6-diaminopyrimidine, 3,4,6-tris(ethyl amino)-1,3,5-triazine, and the like. Although the aldehyde used is typically formaldehyde, other aldehydes may also be used, such as acetaldehyde, crotonaldehyde, acrolein, benzaldehyde, furfural, glyoxal, and the like, and mixtures and combinations thereof.

In one embodiment, a melamine-formaldehyde crosslinking agent, a benzoguanamine-formaldehyde crosslinking agent, a glycoluril-formaldehyde crosslinking agent, or a combination thereof is used as the crosslinking agent for amino resins. Amino resin crosslinking agents are commercially available. Non-limiting examples of suitable commercially available amino resin crosslinking agents include Cymel 303 thickeners, Cymel 1123, Cymel 1170, and the like from Cytec.

The amount of active hydrogen-reactive crosslinking agent may depend on various factors including, for example, the type of a crosslinking agent, the baking time and temperature, the molecular weight of the polymer, and the desired coating properties. The crosslinking agent is typically present in an amount of up to 50 wt %, or up to 30 wt %, or up to 15 wt %, or up to 5 wt %. If used, the crosslinking agent is typically present in an amount of at least 0.1 wt %, or at least 1 wt %, or at least 1.5 wt %. These weight percentages are based on the total weight of the coating composition.

### Adhesion Promoter

The aqueous coating composition further includes a phosphorylated adhesion promoter. It is well known that adhesion promoters may be applied to increase the adhesion of a coating to a substrate. However, when formulating the aqueous coating composition for forming a side seam strip or a side seam coating, the addition of phosphorylated adhesion promoters can further improve the wedge bending and resistance to MEK wiping of the side seam strip or side seam coating.

The phosphorylated adhesion promoter includes phosphorylated epoxidized oil, phosphorylated epoxidized polybutadiene polymer, phosphorylated acrylic copolymer, phosphorylated polyester, epoxy phosphate, phosphorylated epoxy-acrylic copolymer, monoalkyl esters of the foregoing, dialkyl of the foregoing, or mixtures and combinations thereof. In one embodiment, an epoxy phosphate is used as an example of a phosphorylated adhesion promoter, such as the product sold under the trade name ETERKYD SE0501P.

The amount of phosphorylated adhesion promoter contained may depend on various factors including, for example, the type of the adhesion promoter and the desired coating properties. The phosphorylated adhesion promoter is typically present in an amount of up to 20 wt %, or up to 15 wt %, or up to 10 wt %, or up to 5 wt %. If used, the crosslinking agent is typically present in an amount of at least 0.1 wt %, or at least 1 wt %. These weight percentages are based on the total weight of the coating composition.

If desired, the coating composition of the present invention may optionally contain other additives that do not adversely affect the coating composition or the cured coating obtained therefrom. Suitable additives include, for example, those agents that will improve the processability or manufacturability of the composition, enhance the aesthetics of the composition, or improve the particular functional properties or characteristics of the coating composition or the cured composition obtained therefrom, such as adhesion to the substrate. The additives that may be included are carriers, additional polymers, emulsifiers, pigments, metal powders or pastes, fillers, anti-migration aids, antibacterial agents, extenders, lubricants, coagulants, wetting agents, biocides, plasticizers, antifoaming agents, colorants, waxes, antioxidants, corrosion inhibitors, flow control agents, thixotropic agents, dispersants, UV stabilizers, scavengers, or combinations thereof. The content of each optional ingredient is sufficient to serve its intended purpose, and preferably such content does not adversely affect the coating composition or the cured coating obtained therefrom.

Any suitable liquid carrier may be used to prepare the coating composition. Suitable liquid carriers include organic solvents, water and mixtures thereof. A liquid carrier is selected to obtain a dispersion or solution of the polymer of the present invention for further formulation.

The amount of liquid carrier contained in the coating composition varies, for example, depending on the coating method and the amount of solids required. One exemplary embodiment of the coating composition includes at least 30 wt % of a liquid carrier, or at least 35 wt %, or at least 45 wt %. In such an embodiment, the coating composition typically includes up to 85 wt % of a liquid carrier, or up to 80 wt %, or up to 70 wt %, or up to 60 wt %, and still even more preferably less than 55 wt %.

The coating composition is an aqueous coating composition. Therefore, the coating composition includes, based on the total weight of the coating composition, at least about 10 wt % of water, or at least about 20 wt %, or at least about 35 wt % (in some embodiments, about 40 wt % or more of water). In such an embodiment, the coating composition further includes, based on the total weight of the coating composition, at least about 5 wt % of an organic co-solvent, or at least about 10 wt %, or at least about 15 wt %.

Suitable organic co-solvents include alcohols (e.g., ethanol, n-propanol, isopropanol, n-butanol, isobutanol and the like); ketones (e.g., acetone, 2-butanone, cyclohexanone, methyl aryl ketone, ethyl aryl ketone, methyl isoamyl ketone and the like); glycols (e.g., butyl glycol); glycol ethers (e.g., ethylene glycol monomethyl ether, ethylene glycol monoethyl ether, ethylene glycol monobutyl ether, propylene glycol monomethyl ether, methoxy propanol and the like); glycol esters (e.g., butyl glycol acetate, methoxypropyl acetate and the like); and mixtures and combinations thereof. In some embodiments, glycol ethers have been found to be suitable organic co-solvents.

The coating compositions may be prepared in various ways using conventional methods. For example, the coating composition may be prepared by simply mixing the hydroxyl-containing acrylic polymer, urethane component, crosslinking agent, and any other optional ingredients of the present invention in any desired order. The resulting mixture may be mixed until all composition ingredients are substantially uniformly mixed. Alternatively, the coating composition may be made in the form of a liquid solution or dispersion as follows. The optional carrier liquid, hydroxyl-containing acrylic polymer, urethane component, crosslinking agent, and any other optional ingredients of the present invention are mixed in any desired order by stirring sufficiently. An additional amounts of carrier liquid may be added to the coating composition to adjust the amount of non-volatile material in the coating composition to a desired level.

The total amount of solids present in the coating composition may vary depending on various factors including, for example, the desired coating method. At present, various embodiments of the aqueous coating compositions include at least about 20 wt %, or at least about 30 wt %, or at least about 40 wt % of solids, based on the total weight of the aqueous coating composition. In certain embodiments, based on the total weight of the coating composition, the coating composition includes less than about 80 wt %, less than about 70 wt %, or less than about 65 wt % of solids. For certain types of applications, the solids content of the coating composition may be outside the above ranges.

The viscosity of the coating composition may vary depending on various factors including, for example, the desired coating method. In various embodiments, the viscosity of the coating composition is adjusted to be in the range of 10 to 40 seconds (measured with a #4 Ford cup at 25° C.), or 14 to 30 seconds, or 14 to 20 seconds. For certain types of applications, the viscosity of the coating composition may be outside the above ranges.

In some various embodiments, the aqueous coating composition is substantially free of halogenated polyolefins (e.g., PVC), or essentially free of PVC, or essentially completely free of PVC, or completely free of PVC.

The coating composition may be coated onto a substrate using any suitable process, such as spraying coating, roller coating, coil coating, curtain coating, impregnation coating, meniscus coating, kiss coating, knife coating, blade coating, dip coating, slot coating, slide coating and the like and other types of predetermined amount of coating. In some embodiments, the coating composition may be coated onto a substrate using spray coating or roller coating.

After the coating composition is coated onto the substrate, the composition may be cured using various processes including, for example, oven baking with conventional or convective methods. The curing process may be carried out in a separate step or in combined steps. For example, the coated substrate may be dried at ambient temperature so that most of the coating composition remains in an un-crosslinked state. The coated substrate may then be heated to completely cure the composition. In some cases, the coating composition may be dried and cured in a single step.

The curing process may be carried out at any suitable temperature, including, for example, a peak metal temperature in the range of about 180° C. to about 250° C. If the coating composition is coated onto a side seam of a three-piece can, the curing of the coated coating composition may be performed, for example, by subjecting the coated substrate to a peak metal temperature of about 180° C. to about 250° C. for a suitable period of time (e.g., about 1 to about 100 seconds). In one embodiment, the coating composition coating onto the side seam may be cured at a peak metal temperature of 220° C. to 250° C. for 1-10 seconds to form the desired side seam stripe or side seam coating.

The cured coatings are preferably sufficiently adhered to metals such as steel, tin-free steel (TFS), tin plates, electrolytic tin plates (EFP), aluminum and the like, which then provides high levels of tolerance to processing conditions (such as bending) that occur in subsequent manufacturing processes. The coating may be coated onto any suitable surface, including the inner surface of the side seam of the three-piece can or the outer surface of the side seam.

In the embodiment where the outer surface of the can body portion of a three-piece can of the present invention is coated with varnish, the cured coating may be coated on at least a part of the outer varnish and has good compatibility therewith. In such an embodiment, the average coating thickness of the outer varnish is in the range of 1-30 microns; and the average coating thickness of the outer side seam coating is in the range of 1-30 microns.

The coating composition may be used in various coating applications. As mentioned previously, the coating composition is particularly suitable for side seam stripes or side seam coatings on the interior surface or exterior surface of side seams of three-piece packaging containers. Such packaging containers include food or beverage cans; aerosol containers; medical packaging containers such as canisters of metered-dose inhalers (“MDI”) for the storage and administration of pharmaceuticals; and general industrial containers.

The preferred aqueous coating compositions may exhibit one or more of the following properties when properly cured on the side seam of a food or beverage can: at least 70% wedge bending; and/or at least 50 MEK double rubs. Suitable methods for testing these properties are described in the Test Methods section below.

### Test Methods

Unless otherwise stated, the following test methods are used in the examples.

### VOC Content Test

VOC content is an important factor in determining the degree of environmental friendliness of the coating composition. Herein, VOC content is determined according to GBT23986-2009; the VOC content is the VOC content of the sample being tested

$${ρ ( VOC )}_{1 w} = ( \frac{{\sum }_{i = 1}^{i = n} {m}_{i}}{1 - {ρ}_{s} \times \frac{{m}_{w}}{{ρ}_{w}}} ) \times {ρ}_{s} \times 1 \; 000$$

after water is subtracted, expressed in grams per liter (g/L), as follows:
where
ρ(VOC)_{iw} means the VOC content of the sample “being tested” after water is subtracted, in grams per liter (g/L); mᵢ means the mass of compound i in 1 g of the test sample, in grams (g); m_{w} means the mass of water in 1 g of the test sample, in grams (g); ρₛ means the density of the test sample at 23° C. in grams per milliliter (g/mL); ρ_{w} means the density of water at 23° C. in grams per milliliter (g/mL) (=0.997537 g/mL); and 1000 is a conversion factor. If the VOC content of the coating composition exceeds 420 g/L, the coating composition is considered not to be an aqueous coating composition.

### Wedge Bending Test

This test provides an indication of the flexibility and the cured degree of the coating. The test wedge is formed from a coated rectangular metal test piece (length 12 cm×width 5 cm). The test wedge is formed from the coated sheet by folding (i.e., bending) the sheet around the roll. To complete this step, the roll is placed on the coated sheet so that it is oriented parallel to and at equal distance from the 12 cm edge of the sheet. The resulting test wedge has a wedge diameter of 6 mm and a length of 12 cm. To evaluate the wedge bending properties of the coating, the test wedge is placed longitudinally in the metal block of the wedge bending tester; and a 2.4 kg weight is dropped from a height of 60 cm onto the test wedge. Then, the deformed test wedge is immersed in a copper sulfate test solution (made by combining 20 parts of CuSO₄.5H₂O, 70 parts of deionized water, and 10 parts of hydrochloric acid (36%)) for about 2 minutes. The exposed metal is examined under a microscope and the number of millimeters of coating failure along the deformation axis of the test wedge is measured. The results may be shown as the wedge bending percentage calculated as follows:

100%×[(L20 mm)−(failed mm)]/(120 mm)

If the coating exhibits a wedge bending percentage of 70% or more, the coating is considered to pass the wedge bending test.

### Solvent Resistance

The degree of “cure” or crosslinking of the coating can be measured as resistance to solvents such as methyl ethyl ketone (MEK). This test may be performed as described in ASTMD5402-93. The number of double rubs (i.e., one rub forward and one rub backward) is recorded.

### Retort Test

This is a measure of the coating integrity of the coated substrate after exposure to heat and pressure along with a liquid such as water. Retort performance is not necessary for all food and beverage coatings, but is desirable for some product types packaged under retort conditions. This process is similar to disinfection or pasteurization tests. This test was conducted by subjecting the substrate to heating at 105° C.-130° C. and a pressure of 0.7 kg/cm² to 1.05 kg/cm² for 15 to 90 minutes. The coated substrate is then tested for adhesion and blush resistance as described below. In food or beverage applications where retort performance is desired, adhesion ratings of 10 and blush ratings of at least 7 are typically desirable for commercially viable coatings.

### Adhesion Test

An adhesion test may be performed to evaluate whether the coating composition adheres to the coated substrate. The test is carried out according to ASTM D 3359—Test Method B, using SCOTCH 610 tape available from 3M Company, Saint Paul, Minn. Adhesion is generally rated on a scale of 0-10 where a rating of “10” indicates no adhesion failure; a rating of “9” indicates 90% of the coating remains adhered; a rating of “8” indicates 80% of the coating remains adhered, and so on. Herein, if the coating exhibits an adhesion rating of at least 8, the coating is considered to pass the adhesion test.

### Blush Test

A blush test measures how a coating is resistant to various solutions. Typically, blush is measured by the amount of water absorbed into a coated film. When the film absorbs water, it generally becomes cloudy or looks white. Blush is generally measured visually using a scale of 0-10, where a rating of “10” indicates no blush; a rating of “9” indicates slight whitening of the film; a rating of “8” indicates whitening of the film, and so on.

### Copper Sulfate Test

This method provides a method of examining the protective properties of the side seam stripe or side seam coating on the weld joint of a three-piece can and the integrity of the side seam coating. The side of the weld joint of the three-piece can coated with the side seam coating is soaked in a copper sulfate solution (made by combining 20 parts of CuSO₄.5H₂O, 70 parts of deionized water, and 10 parts of hydrochloric acid (36%)) for 3 minutes. Then the weld joint is checked for red-brown copper to determine whether the outer seam coating could provide adequate protection for the weld joint and to determine the integrity of the outer seam coating. It is desirable that no copper-brown copper is observed on the weld joint after the copper sulphate test.

### Scratch Test

The scratch resistance of the coated film is evaluated according to a scratch test. The method is carried out according to the method described in GB/T 9279 standard 20, with tinplate or hard aluminum sheet as the substrate. This test determines the minimum load required to penetrate the coating. According to the standard procedure, the test is carried out on different parts of the test plate, starting from a preset smaller load. Then the load is gradually increased until the coating is penetrated. The minimum load required to penetrate the coating is recorded in grams.

### EXAMPLES

The following examples describe some embodiments of the present invention more specifically; and these examples are merely for illustrative purposes, as various modifications and changes within the scope of the present disclosure will be apparent to those skilled in the art. Unless otherwise stated, all parts, percentages, and ratios reported in the following examples are by weight and all reagents used in the examples are commercially available and can be used directly without further processing.

### Example 1

The components shown in Table 1 below were mixed according to the following procedure to prepare an embodiment of an aqueous coating composition according to the present disclosure: 1) aqueous acrylic emulsion was added to a dispersion tank and was stirred at a moderate speed (600 rpm); 2) an amino resin curing agent, an isocyanate curing agent, and an epoxy phosphate adhesion promoter were added to another dispersion tank; a co-solvent was added therein at a low speed (300 rpm) for pre-mixing and the mixture was dispersed for 15 minutes; 3) an aqueous acrylic emulsion was added into the mixture obtained in step 2) at a moderate stirring speed and the mixture was stirred for 20 minutes; and finally 4) a catalyst, a wax additive, a neutralizing agent, deionized water, and a thickener were added and the mixture was filtered after being stirred for 30 minutes to obtain an aqueous coating composition of the present invention and a corresponding control coating composition.

The resulting aqueous coating composition was thermally cured at a peak metal temperature of 232° C. for 6 seconds to form a cured coating. The resulting cured coating was then tested as described in the Test Methods section. Table 1 below summarizes the wedge bending performance, solvent resistance, salt resistance, scratch resistance, and retort resistance of each coating composition.

TABLE 1
Components and performance of the aqueous coating composition of the present invention

| Component | | Ex1 | CEx1 | Ex2 | CEx2 | Ex3 | CEx3 | Ex4 | CEx4 | Ex5 | CEx5 |
|---|---|---|---|---|---|---|---|---|---|---|---|
| Aqueous | VIACRYL VSC | 30-35% | 30-35% | 30-35% | 30-35% | | | | | 30-35% | 30-35% |
| dispersion | 6276 | | | | | | | | | | |
| of a | Neocryl A 633 | | | | | 30-35% | 30-35% | | | | |
| hydroxyl | WQ1229P | | | | | | | 30-35% | 30-35% | | |
| functional | | | | | | | | | | | |
| acrylic | | | | | | | | | | | |
| polymer | | | | | | | | | | | |
| Polyurethane | PUD (WJ0526) | 5-10% | — | | | | | | | | |
| component | Blocked isocyanate | | | 1-5% | — | 1-5% | — | 1-5% | — | 1-5% | 1-5% |
| | (DesmodurL3175S | | | | | | | | | | |
| | N) | | | | | | | | | | |
| Amino resin | Melamine | 1-2% | 1-2% | 1-2% | 1-2% | 1-2% | 1-2% | 1-2% | 1-2% | 1-2% | 1-2% |
| crosslinking | crosslinking agent | | | | | | | | | | |
| agent | (CYMEL 303LF) | | | | | | | | | | |
| | Benzoguanamine | 1-3% | 1-5% | 1-3% | 1-5% | 1-3% | 1-5% | 1-3% | 1-5% | 1-3% | 1-5% |
| | crosslinking agent | | | | | | | | | | |
| | (CYMEL 1123) | | | | | | | | | | |
| | Glycoluril | 1-3% | 1-5% | 1-3% | 1-5% | 1-3% | 1-5% | 1-3% | 1-5% | 1-3% | 1-5% |
| | crosslinking agent | | | | | | | | | | |
| | (CYMEL 1170) | | | | | | | | | | |
| Epoxy ester | ETERKYD | 1-5% | 1-5% | 1-5% | 1-5% | 1-5% | 1-5% | 1-5% | 1-5% | 1-5% | — |
| Wax | Wax emulsion | 1-2% | 1-2% | 1-2% | 1-2% | 1-2% | 1-2% | 1-2% | 1-2% | 1-2% | 1-2% |
| | (Aquaslip 942) | 1-2% | 1-2% | 1-2% | 1-2% | 1-2% | 1-2% | 1-2% | 1-2% | 1-2% | 1-2% |
| | PTFE modified | | | | | | | | | | |
| | composite | | | | | | | | | | |
| | wax (LANCO | | | | | | | | | | |
| | GLIDD | | | | | | | | | | |
| | 3520) | | | | | | | | | | |
| Co-solvents | N-butanol | 1-5% | 1-5% | 1-5% | 1-5% | 1-5% | 1-5% | 1-5% | 1-5% | 1-5% | 1-5% |
| | Ethylene glycol | 1-5% | 1-5% | 1-5% | 1-5% | 1-5% | 1-5% | 1-5% | 1-5% | 1-5% | 1-5% |
| Deionized | | 35-40% | 40-45% | 35-40% | 35-40% | 35-40% | 40-45% | 35-40% | 40-45% | 35-40% | 35-40% |

Performance Summary

| | | | | | | | | | | |
|---|---|---|---|---|---|---|---|---|---|---|
| Wedge bending/% | 75% | 64% | 79% | 62% | 81% | 69% | 82% | 70% | 79% | 67% |
| Solvent resistance/Number of | 80 | 82 | 70 | 65 | 90 | 88 | 58 | 57 | 70 | 48 |
| Copper sulfate test | No | No | No | No | No | No | No | No | No | No |
| Scratch resistance/g | 700 g | 700 g | 700 g | 700 g | 700 g | 700 g | 700 g | 700 g | 700 g | 700 g |
| Retort resistance (127° C. | No | No | No | No | No | No | No | No | No | No |
| * 60 min) | blush/ | blush/ | blush/ | blush/ | blush/ | blush/ | blush/ | blush/ | blush/ | blush/ |
| | No | No | No | No | No | No | No | No | No | No |
| | adhesion | adhesion | adhesion | adhesion | adhesion | adhesion | adhesion | adhesion | adhesion | adhesion |
| | loss | loss | loss | loss | loss | loss | loss | loss | loss | loss |

From the table above, it can be seen that, when formulating the aqueous coating composition of the present disclosure for forming side seam stripes or side seam coatings, an aqueous coating composition obtained by introducing urethane components into hydroxyl-containing acrylic water-based latex may result in side seam stripes or side seam coatings with better wedge bending performance and/or MEK resistance, as compared to control aqueous coating compositions that do not contain urethane components. Furthermore, the additional addition of phosphorylated adhesion promoters further improves the wedge bending performance and/or MEK resistance of the side seam stripes or side seam coatings, as compared to control aqueous coating compositions that do not contain phosphorylated adhesion promoters.

### Example 2

The aqueous coating composition of an embodiment of the present disclosure was prepared in the same manner as Example 1 and the resulting aqueous coating composition was compared to commercially available solvent-based coating compositions (2875 from PPG and 6875 from Yangrui). The results are summarized in Table 2 below.

TABLE 2
Performance comparison of the aqueous coating composition
of an embodiment of the present invention with conventional
solvent-based coating compositions

| | Performance | | |
|---|---|---|---|
| | The present | | |
| | invention | PPG 2875 | Yangrui 6875 |
| VOC emissions/g/L | 169 | 800 | 800 |
| Copper sulfate test | Pass | Pass | Pass |
| Retort resistance | No blush | No blush | No blush |
| Wedge bending/% | 69% | 70% | 70% |
| Scratch resistance/g | 700 | 700 | 700 |
| Fluidity | Pass | Pass | Pass |

The above results show that when compared with a solvent based coating composition conventionally used to form a side seam or a side seam coating, the aqueous coating composition suitable for forming a side seam or a side seam coating on a three-piece can according to the present invention may produce coatings having substantially the same properties but with a lower VOC content.

Although the present invention has been described with reference to numerous embodiments and examples, those skilled in the art can recognize that other implementations may be devised according to the present disclosure, which does not depart from the protection scope and spirit of the present invention.

1. An aqueous coating composition for use in forming a side seam stripe or coating on three-piece can, the coating composition comprising:
i) an aqueous dispersion of a hydroxyl-functional acrylic polymer;
ii) a urethane component;
iii) a hydroxyl-reactive crosslinker other than component ii); and
iv) an aqueous carrier liquid;
wherein the coating composition has a volatile organic component (VOC) content of less than 420 g/L.

2. The coating composition of claim 1, wherein the urethane component comprises a water-dispersible polyurethane polymer.

3. The coating composition of claim 1, wherein the urethane component comprises a blocked isocyanate.

4. The coating composition of claim 3, wherein the blocked isocyanate is selected from the group consisting of a blocked aliphatic polyisocyanate and a blocked cycloaliphatic polyisocyanate, preferably from the group consisting of blocked hexamethylene diisocyanate, blocked isophorone diisocyanate, blocked bis [4-isocyanatocyclohexyl]methane), blocked tetramethylene-m-xylidene diisocyanate, blocked isopropenyldimethyl-benzylisocyanate and dimers or trimers thereof.

5. The coating composition of claim 1, wherein the urethane component contains an isocyanate content of at least 0.1 wt %, based on the weight of isocyanate for forming the urethane component.

6. The coating composition of claim 1, wherein the component iii) comprises an aminoplast crosslinker.

7. The coating composition of claim 6, wherein the aminoplast crosslinker comprises a melamine-formaldehyde crosslinker, a benzoguanamine-formaldehyde crosslinker, a glycoluril-formaldehyde crosslinker or the combination thereof.

8. The coating composition of claim 1, wherein the hydroxyl-functional acrylic polymer comprises an emulsion polymerized latex polymer.

9. The coating composition of claim 1, wherein the hydroxyl-functional acrylic polymer comprises an organic-solution polymerized acrylic polymer

10. The coating composition of claim 1, wherein the hydroxyl-functional acrylic polymer has an acid number of at least 5 mg KOH per gram resin.

11. The coating composition of claim 1, wherein the hydroxyl-functional acrylic polymer has a hydroxyl number of at least 5 mg KOH per gram resin.

12. The coating composition of claim 1, wherein the coating composition further comprises a phosphatized adhesion promoter.

13. The coating composition of claim 12, wherein the phosphatized adhesion promoter comprises phosphatized epoxidized oil, phosphatized epoxidized polybutadiene copolymers, phosphatized acrylic copolymers, phosphated polyesters, epoxy phosphate, and phosphatized epoxy-acrylic copolymers, mono- and di-alkyl esters of the foregoing, or a combination thereof.

14. The coating composition of claim 1, wherein the coating composition comprises, relative to the total weight of the aqueous coating composition,
30 to 35% by weight of the aqueous dispersion of hydroxyl-functional acrylic polymer;
1 to 10% by weight of the urethane component;
1 to 5% by weight of the aminoplast crosslinker;
1 to 5% by weight of the phosphatized adhesion promoter; and
30-40% by weight of the aqueous carrier liquid.

15. The coating composition of claim 1, wherein the coating composition has a viscosity of from 10 to 40 seconds, as measured with 4# Ford Cup at 25° C.

16. The coating composition of claim 1, wherein the coating composition has a total solids content of 20 wt % to 80 wt %.

17. The coating composition of claim 1, wherein the coating composition is applicable to spray coating or roll coating.

18. The coating composition of claim 1, wherein the coating composition is substantially free of PVC.

19. A three-piece can including a bottom end and a body portion, which the body portion has a side seam formed by joining a metal sheet itself via compression jointing, adhesive jointing, welding or soldering, and wherein an exterior surface of the side seam, an interior surface of the side seam, or both, are coated with a side seam stripe or coating formed from a coating composition of comprising:
i) an aqueous dispersion of a hydroxyl-functional acrylic polymer;
ii) a urethane component;
iii) a hydroxyl-reactive crosslinker other than component ii); and
iv) an aqueous carrier liquid;
wherein the coating composition has a volatile organic component (VOC) content of less than 420 g/L.

20. The three-piece can of claim 19, wherein the side seam stripe or coating is a side seam strip or coating for coating the exterior surface of the side seam.

21. The three-piece can of claim 19, wherein an exterior surface of the body portion is coated with a varnish, and wherein the exterior side seam coating is overlying at least a portion of the varnish.

22. The three-piece can of claim 19, wherein the can further includes a top end and optionally contains a food or beverage product.

23. A process for forming a side seam stripe or coating on three-piece can, comprising:
i) providing an aqueous coating composition comprising:
i) an aqueous dispersion of a hydroxyl-functional acrylic polymer;
ii) a urethane component iii) a hydroxyl-reactive crosslinker other than component ii); and
iv) an aqueous carrier liquid;
wherein the coating composition has a volatile organic component (VOC) content of less than 420 g/L;
ii) coating a side seam of the three-piece can with the coating composition; and
iii) heating the side seam to a peak side seam temperature of at least 180° C., to form the side seam stripe or coating.

24. The process of claim 23, wherein the side seam is heated to a peak side seam temperature of at least 220° C. for 1-30 seconds, to form the side seam stripe or coating.
